(19) United States
(12) Patent Application Publication
(10) Pub. No.: US 2005/0255139 A1
(43) Pub. Date: Nov. 17, 2005

(54) Polymeric compositions with embedded pesticidal desiccants

(76) Inventors: Jonathan L. Hurd, Florence, SC (US); Richard T. Giovannoni, North Wales, PA (US)

Correspondence Address: SUMMA & ALLAN, P.A., 11610 NORTH COMMUNITY HOUSE ROAD, SUITE 200, CHARLOTTE, NC, 28277, US

(21) Appl. No.: 11/127,638

(22) Filed: May 12, 2005

Related U.S. Application Data
(60) Provisional application No. 60/571,654, filed on May 14, 2004.

(51) Int. Cl. A01N 25/00; A01N 33/02; A01N 59/00

(52) U.S. Cl. 424/405; 424/724

(57) ABSTRACT

The invention is a polymeric composition and a method of forming a composition in which a pesticidal desiccant is homogeneously dispersed throughout the polymer. The desiccant is of appropriate size to be incorporated into a polymer melt for eventually forming articles, such as melt spun fibers, from the polymer-desiccant mix. The desiccant may be embedded throughout the body of an article, particularly fibers, produced pursuant to this invention. Silicon dioxide based desiccants that are present within the polymer matrix in an amount between about 0.1 and 2.5 weight percent are useful to provide absorptive properties pursuant to this invention. The desiccant dehydrates the microscopic reservoirs of moisture on which pests, such as a dust mite, survive. In this regard, the invention prevents pests from infesting and thriving on articles formed of the desiccant enhanced polymeric composition.

### CROSS-REFERENCE TO COMMONLY ASSIGNED APPLICATIONS

This application claims the benefit of commonly assigned U.S. Provisional Patent Application Ser. No. 60/571,654 filed May 14, 2004, for Polymeric Compositions with Embedded Pesticidal Desiccants. This application incorporates entirely by reference the provisional application.

This application incorporates entirely by reference the following commonly-assigned patents and patent applications: U.S. Pat. No. 6,599,596, for Methods of Post-Polymerization Injection in Continuous Polyethylene Terephthalate Production; U.S. Pat. No. 6,590,069, for Methods of Post-Polymerization Extruder Injection in Condensation Polymer Production; U.S. Pat. No. 6,573,359, for Methods of Post-Polymerization Injection in Condensation Polymer Production; U.S. Pat. No. 6,569,991, for Methods of Post-Polymerization Extruder Injection in Polyethylene Terephthalate Production; U.S. Pat. No. 6,500,890, for Polyester Bottle Resins Having Reduced Frictional Properties and Methods for Making the Same; U.S. patent application Ser. No. 10/628,077, for Methods for the Late Introduction of Additives into Polyethylene Terephthalate, filed Jul. 25, 2003; U.S. Pat. No. 6,727,306 for Polymer Resins Having Reduced Frictional Properties, filed Jun. 21, 2002; U.S. Pat. No. 6,710,158 for Methods for Making Polyester Bottle Resins Having Reduced Frictional Properties, filed Jun. 21, 2002.

This application also incorporates entirely by reference the following commonly-assigned patents, each of which discusses stoichiometric molar ratios with respect to reactive end groups (i.e., “mole-equivalent branches”): U.S. Pat. No. 6,623,853, for Polyethylene Glycol Modified Polyester Fibers and Method for Making the Same; U.S. Pat. No. 6,582,817, for Nonwoven Fabrics Formed from Polyethylene Glycol Modified Polyester Fibers and Method for Making the Same; U.S. Pat. No. 6,509,091, for Polyethylene Glycol Modified Polyester Fibers; U.S. Pat. No. 6,454,982, for Method of Preparing Polyethylene Glycol Modified Polyester Filaments; U.S. Pat. No. 6,399,705, for Method of Preparing Polyethylene Glycol Modified Polyester Filaments; U.S. Pat. No. 6,322,886, for Nonwoven Fabrics Formed from Polyethylene Glycol Modified Polyester Fibers and Method for Making the Same; U.S. Pat. No. 6,303,739, for Method of Preparing Polyethylene Glycol Modified Polyester Filaments; and U.S. Pat. No. 6,291,066, for Polyethylene Glycol Modified Polyester Fibers and Method for Making the Same.

### BACKGROUND

Pesticides, insecticides, and bug repellants are common in the marketplace. These products are available in various forms to eliminate unwanted organisms. Common pest control substances include chemicals that react and produce pest-repellant gases in order to prevent pests from remaining—or even approaching—the vicinity. Other ways to kill insects, or other pests, include organic compounds that attack the pests' nervous systems. Some anti-pest products are ingested by the pest to eliminate the pest by poisoning. These compounds, however, are often highly reactive and may yield chemical substances that have detrimental effects to surrounding areas.

Although numerous kinds of pesticides are available, most are unsuitable for incorporation into finished articles to achieve a pest resistance. Known pesticides, insecticides, and other additives cannot survive routine manufacturing procedures without significant chemical changes. In some cases, harsh processing conditions cause additives to dissipate, yielding a final product with minimal anti-pest properties. Changes in the pesticide during manufacturing are therefore likely to diminish the pest control effectiveness in the finished product. The addition of chemically active pesticides may also yield undesirable results, such as discoloration or malformation of the article at issue.

Articles such as fibers, fabrics, or molded goods are likely candidates for which pest resistance is highly desirable. A problem arises, however, in forming articles with required additives therein to achieve the desired anti-pest feature. Most of the commonly available pesticides and insecticides have complex chemical compositions. The manufacturing techniques required for many useful articles involve detailed processes with wide fluctuations in temperature, pressure, chemical exposure, and other physically demanding procedures. The manufacturing steps required to produce a useful item often degrade additives and eliminate the possibility of adding commonly available pesticides to the finished product.

Prior researchers have added pesticides, insecticides, microbe-cidal agents, and other additives to manufactured articles. These efforts have occurred in expectation of achieving less biological activity and fewer undesirable living organisms on or around an article. For example, one method of incorporating pest resistance into finished articles includes rubbing insecticides into an outer coating. See U.S. Pat. No. 5,432,000 (column 3, lines 36-42) issued to Young et al. on Jul. 11, 1995. This concept is similar to dusting or spraying insecticides onto finished articles. These processes require an extra processing step and are unreliable in evenly applying the insecticidal treatment. Repeated use of the article may lead to dissipation of the insecticide applied in this manner.

More reliable pesticidal articles incorporate a biologically active ingredient throughout the article during manufacture. In the context of fibers, Japanese Patent Publication No. 08-120524, filed by Nippon Ester Co. on Oct. 20, 1994, states in Paragraph 2 that “fiber obtained by adding an insecticide or an aromatic to polymer and carrying out spinning is known.” The Nippon '524 publication lists various chemical insecticide additives in Paragraph 9 but fails to give any indication of the color, texture, physical attributes, or aesthetic quality of the resulting fiber.

U.S. Pat. No. 5,028,471, issued on Jul. 2, 1991 to Plischke et al., adds terpenes (e.g. d-limonen) to fibers during melt spinning of the filaments. Plischke adds the terpenes to serve as pesticides in the finished article. The Plischke '471 patent does not address the viability of the terpenes at temperatures required for melt spinning. The terpenes of the Plischke '471 patent would likely dissipate at the high temperatures required of many manufacturing processes. Plischke gives no means for manufacturing pest-free fibers or other articles in which the pesticide or insecticide is active in the final product.

Two Japanese patent publications provide further disclosure in regard to adding pest resistance to articles, particularly spun fibers. Japanese Patents JP-2909028 and JP-2836020, both assigned to Jiegaranin and Maeda, add zinc oxide along with other additives, such as silica stones, to the melt before spinning fibers. The silica stones serve as stable base materials to assist in mixing the active zinc oxide into the polymer. The zinc oxide has the physical properties required to withstand melt spinning, but the inventions rely on zinc oxide to repel insects instead of killing insects. Insect repellants, however, are generally less effective than products that actually kill insects.

Adding absorbent materials to a polymer-based manufacturing process has been shown previously. U.S. Pat. No. 5,688,843, issued to Inaoka et al. on Nov. 18, 1997, shows an oil absorbent composition formed by dry or wet mixing a polymer with silica, alumina, calcium carbonate, talc, and diatomaceous earth. The disclosure of the Inaoka '843 patent explains that an oil absorbent composition with added desiccants maintains oil-based agents for gradually releasing aromatics or insecticides into various products. The Inaoka '843 patent relies upon traditional methods of applying the desiccant, such as mixing the desiccant with previously formed fibers.

European Patent Application 91402963.2 (Publication No. 485,277), which Kummermehr filed on Nov. 6, 1991, also shows a desiccant added to previously formed fibers. The Kummermehr '963 publication shows a mineral wool formed by a centrifugal fiber forming process. Inorganic substances are added to the mineral wool to draw in and retain water in a plant cultivation application. The disclosure provides instructions as to adding different clay minerals, aluminum oxide (Al2O3), and silicon dioxide (SiO2). The desiccants listed in the disclosure, however, are added to the mineral wool by applying the additives after the mineral wool has been spun into fibers. Significantly, Kummermehr provides no disclosure showing these added desiccants as insecticides.

U.S. Patent Application No. 2003/0088012 A1, published on May 8, 2003 and filed by Naruse et al. on May 21, 2001, discloses adding silica-based inorganic particles to the melt phase of a fiber spinning process. Naruse preferably incorporates the silica into the core of a core-sheath polyester fiber, but also discloses adding silica to both the sheath and the core. The presence of the silica assists the fiber in retaining its form during the hot washes that are part of the fiber-making processes. The silica particles absorb water during the hot washes but do not crack or otherwise damage the outer sheath of the fiber. Naruse '012 is silent as to whether the silica desiccants add any insecticidal or pesticidal qualities to the fiber.

Using a desiccant as a pesticide has been shown in previous publications, such as U.S. Pat. No. 5,439,690, issued to Knight on Aug. 8, 1995. The Knight '690 patent shows that desiccant particles may be small and sharp enough to work into the joints of an insect. The desiccant particles penetrate the exoskeleton and begin absorbing vital fluids from the insect. The insect cannot survive the desiccant's absorptive process.

A commercially available product known as Segurocera™ also shows desiccants as insecticides. The desiccants of Segurocera™ include boric acid combined with alkaline earth, silica acid, and other inorganic materials. Ishizuka Glass Co., Ltd. manufactures Segurocera™ and advertises that the product is heat resistant to more than 500° C. Segurocera™, therefore, can be used in non-woven cloth, film, fiber, and the like. Segurocera™, however, requires the presence of boric acid as the bioactive element.

PCT Application No. PCT/FR03/00083 (WO 03/056923), filed by Rochat on Jan. 13, 2003, notes that Segurocera™ has been added to a polymer melt to utilize the pesticide in finished products. The Rochat '083 publication points out that Segurocera™ includes glass or ceramic particles in an active ingredient of boric acid. Although Segurocera™ includes silica combinations, the reliance on boric acid prevents its use in manufacturing articles that require less acidic components.

A survey of work in polymer science gives examples of using powdered additives, including silicates, in polymer production. U.S. Pat. No. 6,240,879, issued on Jun. 5, 2001 to Denesuk shows silicate additives controlling undesirable organisms in fibers. The Denesuk '879 patent adds a zinc silicate (column 15, line 33) to the polymer melt of a fiber manufacturing process. The zinc silicate serves as a microbe inhibiting agent. Denesuk relies on microbe-inhibiting agents that interfere with the microbe's nutrition or possibly attack the microbe's nervous system. The active ingredients in the Denesuk '879 patent also have chemical properties that are not desirable in all products.

Another reference to silica based polymer additives occurs in PCT Application PCT/US03/00480 (WO 03/056951) filed internationally by Lelah et al. on Jan. 8, 2003. This application adds silica to a polymer melt to help control gas-forming anti-microbe additives. The silicate powder composition contains anions capable of reacting with hydronium ions to generate an anti-microbial gas in the polymerized article. The Lelah '480 patent is silent, however, as to whether the microbe-cidal gas will effectively kill other pests, including the dust mite. Lelah also is silent as to whether the gas releasing powder is suitable for incorporation into fibers used in consumer goods.

Silicon based additives have been used in the field of polymer processing as protective coatings. The silicon based coatings on a fiber allowed other chemical additives, such as anti-microbial agents, to be controllably released in a finished product. For instance, U.S. Pat. No. 5,180,585, filed by Jacobson et al. on Aug. 9, 1991, disclosed a microbe-inhibiting particle that could be incorporated into a polymer melt to make a fiber or other articles. The Jacobson '585 patent actually discloses individual particles with a core, a first coating of a microbe-inhibiting agent, and a second coating to protect the microbe inhibiting agent. The second coating includes silicates that are porous enough to allow the microbe-cidal chemical coating on the particle to diffuse at a controlled rate. The silicates of Jacobson '585, although added to the polymer melt, do not actively affect undesirable organisms. Jacobson's double coated particles are added to polymers, included in a finished product, and release microbe-cidal agents through the silicon based protective coating.

Another disclosure in the progression of silicon based additives in polymer processing is PCT Application No. PCT/US99/01917 (WO 99/41438), filed by Hartzog et al. on Aug. 19, 1999. As Hartzog explains, “much effort has been directed at embedding metal ions, which have long been known to have an anti-microbial effect, in polymers to give antimicrobial activity in fibers.” The metal ions described by Hartzog are traditionally zeolites that pump out ions to be ingested by the microbes. The ions interfere with vital body functions, and the microbe does not survive the ion attack. Hartzog makes use of this process by producing a dual part fiber, with a core section surrounded by a sheath. The core section contains the active metal biocides. The sheath may comprise either silica, silicates, borosilicates, aluminosilicates, alumina, or mixtures thereof. The sheath of silicates acts as a shield to controllably release the ions and kill the microbes. The Hartzog '917 fiber is a melt-spun fiber with the silicates added to the melt. The active ingredients of Hartzog '917 are limited to a fiber core that is protected by a silicate sheath. The silicates of Hartzog '917 have no pesticidal role in the resulting fiber.

A final disclosure utilizing protective silicon layers around an active fiber core is PCT Application No. PCT/FR00/02337 (WO 01/11956), filed by Canova and Rochat on Aug. 18, 1999. Canova '337 adds an anti-acarid, biologically active element to the polymer solvent. The disclosed biocide may be silver, copper, or zinc compounds that interfere with a pest's food supply and digestion process. The silica once again serves as a protective layer around the active core.

Prior research in the field fails to address the need for a pest resistant polymeric composition with an additive that has the physical qualities required to withstand the manufacturing processes.

### SUMMARY OF THE INVENTION

One objective of the invention is to provide a polymeric composition that includes a pesticidal desiccant therein to dehydrate the microscopic moisture available for pests to thrive on or near the composition.

In one embodiment, the invention is a polymeric composition that includes a silicon dioxide based pesticidal desiccant homogeneously dispersed throughout the polymer. The desiccant dehydrates microscopic reservoirs of moisture that pests need to survive on or around the polymer. The dehydration prevents pests from infesting and thriving on articles made of the polymeric composition.

In another embodiment, the invention is a polymeric composition that is used to form fibers that are resistant to pests, especially dust mites. The fiber includes a silicon dioxide based desiccant that is homogeneously dispersed throughout the body of the fiber. The fiber achieves pest resistance by dehydrating pests that attempt to infest the fiber.

In yet another embodiment, the invention is a pest resistant fiber formed by adding desiccants other than silicon dioxide based desiccants to the polymer during the fiber manufacturing process. Although the desiccants of this embodiment do not utilize silicon dioxide as the primary constituent, the desiccant additives dehydrate the microscopic regions where pests, such as dust mites, live and breed.

In another embodiment, this invention is a method of forming pest resistant fibers by admixing a pesticidal desiccant to a polymer melt to embed the desiccant into the melt. The method homogeneously disperses the desiccant throughout the polymer to ultimately achieve a melt-spun fiber with insufficient moisture to support living organisms such as a dust mite.

### DETAILED DESCRIPTION

The invention is a polymeric composition and a method of producing a composition that is useful in forming articles having improved resistance to pests. The composition includes a polymer with a pesticidal desiccant incorporated therein. The desiccant dehydrates microscopic regions of the polymer in which pests and microorganisms tend to thrive. The desiccant deprives these pests and microscopic organisms the water moisture required to survive on or within the polymer. The arid microscopic environment reduces, if not eliminates, pests and microorganisms existing on articles made of a desiccant-enhanced polymeric composition.

The present invention addresses the problems inherent in manufacturing articles with insecticides, pesticides, and repellants incorporated into a finished product. To alleviate the problems of chemical degradation of pesticidal additives during manufacturing, the present invention uses more robust additives capable of withstanding a wider range of manufacturing processes.

The invention utilizes a pesticidal desiccant additive that is capable of eliminating pests from an article by dehydrating the pests to the point of extinction. The invention eliminates the problems of certain manufacturing processes disrupting the pesticidal effectiveness of the additive. The chosen desiccants are capable of withstanding high temperatures without dissipating and allow for a wider range of manufacturing steps without disintegrating. The desiccant may be added to the raw materials used to make an article of manufacture and yield an article with desirable pest resistant qualities.

One particularly useful embodiment of the invention herein encompasses fibers made of the pesticidal polymeric composition. The fibers are especially advantageous in that pests, particularly dust mites, cannot survive in the microscopic regions of the dehydrated polymeric composition.

Dust mites thrive in moist conditions, such as the environment provided when fibers within sheets, bedding, fillers, and other products absorb water. Polymeric fibers within these articles ordinarily absorb low levels of moisture from the humidity in the environment or possibly from bodies in contact with the fibers. Humans, for instance, sweat on sheets, and human sweat is a source of hydration for organisms living on the fibers within the sheets.

The polymeric composition described and claimed herein achieves superior pest resistance by having a desiccant incorporated into the polymer, preferably during the melt phase of manufacturing. In one embodiment, the desiccant is a powder having particles that are sufficiently small to embed within a molten polymer. The desiccant is thereby homogeneously dispersed throughout the polymer composition. The desiccant is entirely embedded within the polymer, as the invention does not require that the desiccant particles be exposed to the atmosphere to any specific degree.

The present invention encompasses the use of the pesticidal polymeric composition in fibers that are effective in controlling pest infestation, particularly dust mite growth, in articles made of the claimed fiber. Finished articles, including but not limited to pillows, bedding, furniture filler, and carpeting, are within the scope of uses for a fiber made of the pesticidally enhanced polymeric composition.

The fiber of this invention includes a melt-spun fiber made of nylon or polyester. The pesticidal desiccant may be added to the polymer melt before spinning or during other processing steps. The desiccants chosen for the invention are capable of withstanding high temperature and rigorous processing that are common in fiber manufacturing methods.

The desiccant is mixed into the polymer melt and completely embedded into the polymer. The term “embedded,” as used herein, means that the desiccant particles need not be exposed to the surface of the polymer in order to function as desired. As another explanation, the term “embedded” means that the desiccant does not have to be separated from the polymer to any particular degree to dehydrate the moisture on which microorganisms thrive.

The desiccant is homogeneously dispersed throughout the polymer in the manufacturing process. Fibers spun from the polymer, therefore, include the pesticidal desiccant homogeneously dispersed and embedded throughout the fiber.

Without limiting the invention to any one manufacturing technique, the desiccant may be added late in the polymer forming process. Commonly assigned patents, incorporated entirely by reference above (i.e., U.S. Pat. Nos. 6,599,596; 6,569,991; 6,573,359; 6,590,069), disclose processes for the late addition of additives to polymer. In particular, these patents show the incorporation of additives by post-polymerization injection. The pesticidal desiccants described herein may be incorporated into the polymer according to the processes disclosed by the above noted references.

The pesticidal desiccants used in the pest resistant polymeric composition may include several different varieties. Many types of desiccants will provide the microscopic dehydration and prohibit the proliferation of microorganisms according to this invention. The following compositions are examples of desiccants that yield good results according to the teachings herein. The description presented for each of these desiccants is available from public resources:

Precipitated Silica

Precipitated silica is a synthetic product produced by the precipitation reaction of sodium silicate with sulfuric acid. The precipitated slurry is washed and then dried by one of several methods. Milling and granulating are common processes used to achieve specified particle sizes. Silica shows good desiccant properties at temperatures up to 220° F. (105° C.). Silica is a good desiccant additive for polymeric compositions to be used at ambient conditions because silica shows optimal performance as a desiccant at room temperatures (70° to 90° F.) and high humidity (60 to 90 percent relative humidity).

Diatomaceous Earth (Diatomite, Kieselguhr)

Diatomaceous earth is a naturally occurring silica powder made of the skeletal remains of planktonic algae. Each particle of diatomaceous earth is sufficiently porous to give diatomite high surface area and high water absorption.

Molecular Sieve (Synthetic Zeolite)

Molecular sieve is a porous crystalline aluminum silicate that has excellent desiccant properties due to its natural attraction for moisture molecules. Molecular sieve has physical properties that may be controlled in the fabrication process. In particular, molecular sieve has uniform pore size openings that can be predicted and controlled when creating the composition. Molecular sieve can hold moisture to temperatures well past 450° F. (230° C.).

Montmorillonite Clay

Montmorillonite clay is a naturally occurring magnesium aluminum silicate of the sub-bentonite mineral type that has been dried according to well known methods. Montmorillonite clay is a standard basic desiccant that works best in normal temperature and humidity environments.

Calcium Oxide

Calcium oxide is calcinated or recalcinated lime characterized by the ability to absorb significant amounts of water in environments with low relative humidity. Publicly available test data shows that calcium oxide has a moisture adsorptive capacity of not less than 28.5 percent by weight. Calcium oxide adsorbs water slowly but is an effective adsorbent even at very low levels of moisture.

Calcium Sulfate (Drierite™)

Calcium sulfate is a desiccant created by the controlled dehydration of gypsum. Calcium sulfate is regarded as a general purpose desiccant and is often used in laboratory procedures. Calcium sulfate tends to retain any absorbed water, as it does not release the water easily when exposed to higher ambient temperatures. Tests show that calcium sulfate adsorbs only up to 10 percent of its weight in water vapor.

Activated Alumina (Aluminum Oxide)

Activated alumina is a porous desiccant which performs very similarly to silica. Activated alumina provides lower moisture capacity at low temperatures. The desiccant performance of activated alumina improves at higher temperatures. Activated alumina is often used as an effective desiccant for drying gases.

One group of desiccants available to practice the invention herein includes those desiccants in which the silicon dioxide content is greater than other constituents of the desiccants on a weight concentration basis. These silicon dioxide based desiccants include precipitated silica, diatomaceous earth, and sodium aluminum silicate. Other desiccants, such as molecular sieve (synthetic zeolite), montmorillonite clay, calcium oxide, calcium sulfate (Drierite™), and activated alumina (aluminum oxide), are also viable alternatives in achieving the desired dehydration by which the polymeric composition of this invention eliminates microorganisms. All of the desiccants listed here, as well as mixtures and combinations, are available to achieve the required fiber dehydration of this invention.

Each of these desiccants is available for all embodiments of the invention herein. The desiccants listed above are offered only as examples, and the list is not intended to be exhaustive. The polymeric composition according to this invention may incorporate mixtures of any combination of available desiccants and achieve the goal of dehydrating microscopic amounts of moisture to enhance pest resistance.

One preferred embodiment of the current invention includes the use of desiccants that are predominantly silicon dioxide based compositions. The term “predominantly,” as used herein, means, without limitation, a degree of prevalence in an amount greater than any other constituent. “Predominantly” may indicate that the constituent is present in an amount greater than 50 percent of the whole but is not limited to that definition. For example, a predominant constituent of a composition may be more prevalent than all other constituents on a weight basis without making up more than 50 percent of the weight of the composition.

Of the desiccants listed above, precipitated silica, diatomaceous earth, and sodium aluminum silicate showed excellent results as a silicon dioxide based pesticidal desiccant within a polymeric composition. Without being bound to any one theory of operation, research suggests that silicon dioxide is the active ingredient enhancing the pesticidal qualities of precipitated silica, diatomaceous earth, and sodium aluminum silicate. Silicon dioxide is also present to a lesser extent in molecular sieve and montmorillonite clay.

The polymeric composition of the instant invention may incorporate a pesticidal desiccant composed predominantly of silicon dioxide. Incorporating between about 0.1 and 2.5 weight percent of a pesticidal desiccant within the polymer results in a polymeric composition with insufficient ambient moisture available for pests to thrive on or near the polymer. In another embodiment, the polymeric composition includes at least about 0.1 weight percent but less than 1 weight percent of a pesticidal desiccant. Yet another embodiment of the invention includes between about 1 and 2 weight percent of a pesticidal desiccant in the polymer. A last embodiment incorporates between about 2 and 2.5 weight percent of the pesticidal desiccant in the polymer.

The term “ambient moisture,” as used herein, refers to low levels of moisture available within a polymeric composition. The “ambient moisture” is that moisture available on a microscopic level that would ordinarily support microscopic living organisms within a polymeric composition.

Ordinarily, moisture from the atmosphere or from bodies in contact with the polymeric composition deposit microscopic amounts of water on which pests such as dust mites hydrate themselves. The water sources on or near the polymeric composition enable microscopic organisms to infest the polymer or articles made of the polymer.

For embodiments of the instant invention that incorporate a pesticidal desiccant into a polymeric composition, particular success has been shown by using a pesticidal desiccant composed predominantly of silicon dioxide on a weight basis. Precipitated silica and diatomaceous earth are two silicon dioxide based desiccants used herein. On a weight basis, precipitated silica and diatomaceous earth have a composition that is more than 85 percent silicon dioxide. More specifically, precipitated silica may include between about 95 and 99 percent silicon dioxide, and diatomaceous earth may include between about 88 and 92 percent silicon dioxide. Sodium aluminum silicate is also a useful desiccant for this invention with a composition by weight that is more than 35 percent silicon dioxide. In fact, sodium aluminum silicate typically includes between about 40 and 45 percent silicon dioxide. Adding these desiccants to a polymer melt in powder form has been especially efficient.

In one embodiment, the desiccant is precipitated silica comprising, on a dry basis, about 95 to 99 percent silicon dioxide (SiO₂), about 0.5 to 2 percent sodium oxide (Na₂O), less than about 0.25 percent ferric oxide (Fe₂O₃) and about 0.5 to 1.0 percent sulfur trioxide (SO₃).

In a second embodiment, the desiccant is diatomaceous earth comprising, on a dry basis, about 88 to 92 percent silicon dioxide (SiO₂), about 0.25 to 0.8 percent sodium oxide (Na₂O), about 2 to 5 percent aluminum oxide (Al₂O₃), about 0.5 to 3 percent ferric oxide (Fe₂O₃) and about 2 to 5 percent other oxides.

A third embodiment utilizes sodium aluminum silicate as the silicon dioxide based desiccant. The sodium aluminum silicate of this invention comprises, on a dry basis, about 40 to 45 percent silicon dioxide (SiO₂), about 20 to 25 percent sodium oxide (Na₂O), about 32 to 38 percent aluminum oxide (Al₂O₃), and less than about 0.25 percent ferric oxide (Fe₂O₃).

Each of the chosen silicon dioxide based desiccants, namely precipitated silica, diatomaceous earth, and sodium aluminum silicate, may be added to polymer in an appropriate amount to achieve the desired pest resistance by dehydrating ambient moisture. One preferred polymeric composition includes precipitated silica at a weight concentration that is between about 0.15 and 0.75 percent of the total weight of the polymeric composition.

Alternatively, when the selected silicon dioxide based desiccant is diatomaceous earth, the optimal pest resistance occurs at a weight concentration of diatomaceous earth that is between 0.35 and 1.0 percent of the total weight of the composition.

Finally, the invention shows improved pest resistance with a polymeric composition wherein the desiccant is sodium aluminum silicate at a weight concentration that is between about 0.65 and 0.8 percent of the total weight of the composition.

The polymer to which the desiccant is added may be selected from many available materials. The pesticidal desiccants of this invention increase the pest resistance of polyester and nylon compositions as well as polymers of acrylonitrile and polyolefins. The polyolefins may include polypropylene and polyethylene.

Pest resistant polyesters formed according to the disclosure herein include polyethylene terephthalate (PET), polybutylene terephthalate (PBT), polytrimethylene terephthalate (PTT). Alternative polymers, in which the instant invention is useful to add a pest resistant quality, include polyurethanes, polycarbonates, polyamides, and polyimides.

The invention enhances the pest resistance of each polymer noted above. The pest resistant polymeric composition is useful for forming articles with less pest infestation. The articles formed from the polymers described herein include fibers and filaments used throughout industry today. A melt-spun fiber incorporating the pesticidal polymeric composition described above is particularly useful for bedding, pillows, furniture filler, quilts, and the like.

In one preferred embodiment, a pesticidal desiccant is added to the above-described polymeric composition during the melt phase of a polymer production process. After mixing the desiccant into the polymer melt, the desiccant and polymer are spun to form melt-spun fibers. The desiccants of this invention impart the desired pest resistant quality into the final product.

The fibers are composed of the pesticidal polymer composition enhanced with a desiccant additive as described above. These fibers have a pesticidal desiccant homogeneously dispersed throughout the body of the fiber. The desiccant may be entirely embedded within the polymer, as this invention does not require the desiccant particles to be exposed, to jut out from the surface of the fiber, or to be separated from the fiber to any specific degree.

The desiccant enhanced polymeric fiber has the property of absorbing low levels of moisture within the fibers. The absorption process creates an arid microscopic atmosphere in which microorganisms, particularly the dust mite, cannot survive. This microscopic ambient atmosphere is dehydrated and does not hold the reservoirs of water moisture that organisms require to sustain life. Organisms, especially the dust mite, may initially reside on the polymeric fiber or within an article composed of the fibers. The dehydrated microscopic ambient atmosphere, however, dehydrates the organism and eliminates the microorganism population.

Dust mites are unable to infest a fiber made with an embedded pesticidal desiccant. The anti-dust mite fiber is especially useful in forming sheets, bedding, furniture fillers, quilting, mattresses and the like. The dehydrated ambient atmosphere of the desiccant-enhanced polymeric composition yields an anti-dust mite quality to these articles. Less dust mite growth is helpful for purposes of reducing allergens and eliminating biologically active organisms from the article.

In one preferred embodiment, the dehydration effect is effectively enhanced in the claimed fiber by adding a powdered desiccant to the polymer melt before spinning the fiber. The powdered desiccant is embedded within the polymer as described above.

Desiccants that consist predominantly of silicon dioxide on a weight basis are exceptionally useful to eliminate dust mite populations on melt-spun fibers. Due to the fact that the desiccant is embedded within the polymer of the fiber and dispersed homogeneously throughout the fiber, powdered silicon dioxide based desiccants are the preferred additive. In one embodiment, the predominantly silicon dioxide based desiccant is a powder with particles having a surface area to volume ratio less than about 130 m²/ml. In another embodiment, the predominantly silicon dioxide based desiccant is a powder with particles having a surface area to volume ratio less than about 100 m²/ml. In yet another embodiment, the predominantly silicon dioxide based desiccant is a powder with particles having a surface area to volume ratio less than about 80 m²/ml. In fact, the silicon dioxide based particles may have a surface area to volume ratio less than 30 m²/ml in accordance with the invention herein. Desiccants with these properties have a natural tendency to mix well within the polymer melt for a homogeneous dispersal of desiccant.

The previously noted pesticidal desiccants, having a weight concentration that is predominantly silicon dioxide, are useful in forming the fibers of this embodiment. Precipitated silica, diatomaceous earth, and sodium aluminum silicate, described above in relation to the polymeric composition of this invention, are good choices for the pesticidal desiccant for the fiber embodiment. One preferred embodiment of the invention is a polymeric fiber having the silicon dioxide based desiccant embedded therein of an amount between about 0.1 and 2.5 weight percent of the polymer. In another embodiment, the polymeric fiber includes at least about 0.1 weight percent but less than 1 weight percent of a pesticidal desiccant. Yet another embodiment of the invention includes between about 1 and 2 weight percent of a pesticidal desiccant in the fiber. A last embodiment incorporates between 2 and 2.5 weight percent of the pesticidal desiccant in the fiber.

For embodiments of this invention utilizing a silicon dioxide based desiccant in a pesticidal fiber, the silicon dioxide based desiccants may have the same compositional features as described above for the polymeric composition. The desiccant is ultimately present in the individual fibers at the same weight concentrations as previously described for the overall embodiment of a pesticidal polymeric composition. The above descriptions for the polymeric compositions with precipitated silica, diatomaceous earth, and sodium aluminum silicate are all equally applicable for the individual fiber embodiment. As such, those descriptions will not be repeated but apply equally to each embodiment of the invention.

Pesticidally enhanced polymeric fibers of the present invention encompass, but are not limited to, fibers made of polyethylene terephthalate (PET), polybutylene terephthalate (PBT), and polytrimethylene terephthalate (PTT). The polymer may be selected from the group consisting of polyurethanes, polycarbonates, polyamides, and polyimides. Another embodiment includes a nylon fiber with a pesticidal desiccant incorporated according to the disclosure of this invention. Pesticidal desiccants work equally well with polymers of acrylonitrile and polyolefins. The polyolefins include polypropylene and polyethylene. These choices for the polymer used in practicing the invention herein are examples only and are not intended to limit the scope of the invention. In fact, the polymer may include blends of any of these polymer choices as necessary or desired.

The fibers of the instant invention may be used in a wide range of applications including, but not limited to, quilting, bedding, mattresses, furniture filler, sheets, fiber fill, and the like. The polymeric fiber described and claimed herein may be a staple filament, a yarn, or any other fibrous form in which pests such as dust mites present problems.

A pest-resistant polymeric fiber including polyethylene terephthalate (PET) as the constituent polymer is one useful embodiment of this invention. The PET fiber includes between about 0.1 and 2.5 weight percent of a pesticidal desiccant for dehydrating ambient moisture available for pests to thrive on the fiber. On a weight basis, the pesticidal desiccant is predominantly silicon dioxide, and the pesticidal desiccant is homogeneously dispersed throughout the fiber. As described above, this fiber may also incorporate the pesticidal desiccant by adding a powder in which the particles of the powder have a surface area to volume ratio less than about 100 m²/ml.

The polyethylene terephthalate (PET) fiber of the invention herein incorporates all of the features described above for the polymeric composition and for the fibers of various other polymers. Each of the desiccants listed above and others available on the market may be successfully dispersed throughout PET polymer to form a pest-free fiber according to this invention.

Those of skill in the art will be familiar with known methods of forming PET polymeric fibers that may be used in accordance with the invention herein. Accordingly, in one aspect the invention embraces polyethylene terephthalate polymers that are composed of about a 1:1 molar ratio of a terephthalate component and a diol component (i.e., a terephthalate moiety and a diol moiety). The terephthalate component is typically either a diacid component, which includes mostly terephthalic acid, or a diester component, which includes mostly dimethyl terephthalate. The diol component comprises mostly ethylene glycol.

The diol component usually forms the majority of terminal ends of the polymer chains and so is present in the resulting polyester composition in slightly greater fractions. This is what is meant by the phrases “about a 1:1 molar ratio of a terephthalate component and a diol component,” “about a 1:1 molar ratio of a diacid component and a diol component,” and “about a 1:1 molar ratio of the diester component and the diol component,” each of which is used herein to describe the polyester compositions of the present invention.

Those having ordinary skill in the art will also appreciate that most commercial polyethylene terephthalate polymers are, in fact, modified polyethylene terephthalate polyesters. Indeed, the polyethylene terephthalate resins described herein are preferably modified polyethylene terephthalate polyesters. In this regard, the modifiers in the terephthalate component and the diol component are typically randomly substituted in the resulting polyester composition.

Those having ordinary skill in the art will appreciate that the step of reacting a terephthalate component and a diol component typically means reacting either a diacid component (e.g., mostly terephthalic acid) or a diester component (e.g., mostly dimethyl terephthalate) with ethylene glycol to form polyethylene terephthalate precursors.

As used herein, the term “comonomer” is intended to include monomeric and oligomeric modifiers. It is further within the scope of invention to employ polyether polyols or polyalkylene glycols, such as polyethylene glycol or polytetramethylene glycol. It is still further within the scope of invention to employ a mixture of two or more different kinds of polyols.

As used herein, the term “diol component” refers primarily to ethylene glycol, although other diols (e.g., diethylene glycol) may be used as well.

The term “terephthalate component” broadly refers to diacids and diesters that can be used to prepare polyethylene terephthalate. In particular, the terephthalate component mostly includes either terephthalic acid or dimethyl terephthalate, but can include diacid and diester comonomers as well. In other words, the “terephthalate component” is either a “diacid component” or a “diester component.”

The term “diacid component” refers somewhat more specifically to diacids (e.g., terephthalic acid) that can be used to prepare polyethylene terephthalate via direct esterification. The term “diacid component,” however, is intended to embrace relatively minor amounts of diester comonomer (e.g., mostly terephthalic acid and one or more diacid modifiers, but optionally with some diester modifiers, too).

Similarly, the term “diester component” refers somewhat more specifically to diesters (e.g., dimethyl terephthalate) that can be used to prepare polyethylene terephthalate via ester exchange. The term “diester component,” however, is intended to embrace relatively minor amounts of diacid comonomer (e.g., mostly dimethyl terephthalate and one or more diester modifiers, but optionally with some diacid modifiers, too).

The diol component can include other diols besides ethylene glycol (e.g., diethylene glycol, polyethylene glycol, 1,3-propane diol, 1,4-butane diol, 1,4-cyclohexane dimethanol, neopentyl glycol, and isosorbide), or the terephthalate component, in addition to terephthalic acid or its dialkyl ester (i.e., dimethyl terephthalate), can include modifiers such as isophthalic acid or its dialkyl ester (i.e., dimethyl isophthalate), 2,6-naphthalene dicarboxylic acid or its dialkyl ester (i.e., dimethyl 2,6 naphthalene dicarboxylate), adipic acid or its dialkyl ester (i.e., dimethyl adipate), succinic acid, its dialkyl ester (i.e., dimethyl succinate), or its anhydride (i.e., succinic anhydride), or one or more functional derivatives of terephthalic acid.

For polyethylene terephthalate fibers according to the present invention, no comonomer substitution is necessary, but where employed, preferably includes diethylene glycol or polyethylene glycol.

It will be understood that diacid comonomer should be employed when the terephthalate component is mostly terephthalic acid (i.e., a diacid component), and diester comonomer should be employed when the terephthalate component is mostly dimethyl terephthalate (i.e., a diester component).

It will be further understood by those having ordinary skill in the art that to achieve the polyester composition of the present invention a molar excess of the diol component is reacted with the terephthalate component (i.e., the diol component is present in excess of stoichiometric proportions).

In reacting a diacid component and a diol component via a direct esterification reaction, the molar ratio of the diacid component and the diol component is typically between about 1.0:1.0 and 1.0:1.6.

Alternatively, in reacting a diester component and a diol component via an ester interchange reaction, the molar ratio of the diester component and the diol component is typically greater than about 1.0:2.0.

Those having ordinary skill in the art will know that there are two conventional methods for forming polyethylene terephthalate. These methods are well known to those skilled in the art.

One method employs a direct esterification reaction using terephthalic acid and excess ethylene glycol. In this technique, the aforementioned step of reacting a terephthalate component and a diol component includes reacting terephthalic acid and ethylene glycol in a heated esterification reaction to form monomers and oligomers of terephthalic acid and ethylene glycol, as well as a water byproduct. To enable the esterification reaction to go essentially to completion, the water must be continuously removed as it is formed. The monomers and oligomers are subsequently catalytically polymerized via polycondensation to form polyethylene terephthalate polyester. Ethylene glycol is continuously removed during polycondensation to create favorable reaction kinetics.

The other method involves a two-step ester exchange reaction and polymerization using dimethyl terephthalate and excess ethylene glycol. In this technique, the aforementioned step of reacting a terephthalate component and a diol component includes reacting dimethyl terephthalate and ethylene glycol in a heated, catalyzed ester exchange reaction (i.e., transesterification) to form bis(2-hydroxyethyl)-terephthalate monomers, as well as methanol as a byproduct.

To enable the ester exchange reaction to go essentially to completion, the methanol must be continuously removed as it is formed. The bis(2-hydroxyethyl) terephthalate monomer product is then catalytically polymerized via polycondensation to produce polyethylene terephthalate polymers. The resulting polyethylene terephthalate polymers are substantially identical to the polyethylene terephthalate polymer resulting from direct esterification using terephthalic acid, albeit with some minor chemical differences (e.g., end group differences).

Polyethylene terephthalate polyester may be produced in a batch process, where the product of the ester interchange or esterification reaction is formed in one vessel and then transferred to a second vessel for polymerization. Generally, the second vessel is agitated and the polymerization reaction is continued until the power used by the agitator reaches a level indicating that the polyester melt has achieved the desired intrinsic viscosity and, thus, the desired molecular weight. More commercially practicable, however, is to carry out the esterification or ester interchange reactions, and then the polymerization reaction as a continuous process. The continuous production of polyethylene terephthalate results in greater throughput, and so is more typical in large-scale manufacturing facilities.

In the present invention, the direct esterification reaction is preferred over the older, two-step ester exchange reaction.

In a typical, exemplary process the continuous feed enters the direct esterification vessel that is operated at a temperature of between about 240° C. and 290° C. and at a pressure of between about 5 and 85 psia for between about one and five hours. The esterification reaction forms low molecular weight monomers, oligomers, and water. The water is removed as the reaction proceeds to drive favorable reaction equilibrium.

Thereafter, the low molecular weight monomers and oligomers are polymerized via polycondensation to form polyethylene terephthalate polyester. This polycondensation stage generally employs a series of two or more vessels and is operated at a temperature of between about 250° C. and 305° C. for between about one and four hours. The polycondensation reaction usually begins in a first vessel called the low polymerizer. The low polymerizer is operated at a pressure range of between about 0 and 70 torr. The monomers and oligomers polycondense to form polyethylene terephthalate and ethylene glycol.

The ethylene glycol is removed from the polymer melt using an applied vacuum to drive the reaction to completion. In this regard, the polymer melt is typically agitated to promote the escape of the ethylene glycol from the polymer melt and to assist the highly viscous polymer melt in moving through the polymerization vessel.

As the polymer melt is fed into successive vessels, the molecular weight and thus the intrinsic viscosity of the polymer melt increases. The temperature of each vessel is generally increased and the pressure decreased to allow greater polymerization in each successive vessel.

The final vessel, generally called the “high polymerizer,” is operated at a pressure of between about 0 and 40 torr. Like the low polymerizer, each of the polymerization vessels is connected to a vacuum system having a condenser, and each is typically agitated to facilitate the removal of ethylene glycol. The residence time in the polymerization vessels and the feed rate of the ethylene glycol and terephthalic acid into the continuous process is determined, in part, based on the target molecular weight of the polyethylene terephthalate polyester. Because the molecular weight can be readily determined based on the intrinsic viscosity of the polymer melt, the intrinsic viscosity of the polymer melt is generally used to determine polymerization conditions, such as temperature, pressure, the feed rate of the reactants, and the residence time within the polymerization vessels.

Note that in addition to the formation of polyethylene terephthalate polymers, side reactions occur that produce undesirable by-products. For example, the esterification of ethylene glycol forms diethylene glycol, which is incorporated into the polymer chain. As is known to those of skill in the art, diethylene glycol lowers the softening point of the polymer. Moreover, cyclic oligomers (e.g., trimer and tetramers of terephthalic acid and ethylene glycol) may occur in minor amounts. The continued removal of ethylene glycol as it forms in the polycondensation reaction will generally reduce the formation of these by-products.

After the polymer melt exits the polycondensation stage, typically from the high polymerizer, the polymer melt is generally filtered and extruded. After extrusion, the polyethylene terephthalate is quenched, preferably by spraying with water, to solidify it. Depending upon the application at hand, the solidified polyethylene terephthalate polyester may be cut into chips or pellets for storage and handling purposes.

Although the prior discussion assumes a continuous production process, it will be understood that the invention is not so limited. The teachings disclosed herein may be applied to semi-continuous processes and even batch processes.

Each embodiment of the PET fiber described herein, used in accordance with the present invention, has physical qualities unique to that embodiment. One characteristic that differentiates the embodiments of PET is the “intrinsic viscosity” of the fiber. As used herein, the term “intrinsic viscosity” is the ratio of the specific viscosity of a polymer solution of known concentration to the concentration of solute, extrapolated to zero concentration. Intrinsic viscosity, which is widely recognized as standard measurements of polymer characteristics, is directly proportional to average polymer molecular weight. See, e.g., Dictionary of Fiber and Textile Technology, Hoechst Celanese Corporation (1990); Tortora & Merkel, Fairchild's Dictionary of Textiles (7^{th} Edition 1996).

Intrinsic viscosity can be measured and determined without undue experimentation by those of ordinary skill in this art. For the intrinsic viscosity values described herein, the intrinsic viscosity is determined by dissolving the copolyester in orthochlorophenol (OCP), measuring the relative viscosity of the solution using a Schott Autoviscometer (AVS Schott and AVS 500 Viscosystem), and then calculating the intrinsic viscosity based on the relative viscosity. See, e.g., Dictionary of Fiber and Textile Technology (“intrinsic viscosity”).

In particular, a 0.6-gram sample (+/−0.005 g) of dried polymer sample is dissolved in about 50 ml (61.0-63.5 grams) of orthochlorophenol at a temperature of about 105° C. Fiber and yarn samples are typically cut into small pieces, whereas chip samples are ground. After cooling to room temperature, the solution is placed in the viscometer at a controlled, constant temperature, (e.g., between about 20° and 25° C.), and the relative viscosity is measured. As noted, intrinsic viscosity is calculated from relative viscosity.

Those having ordinary skill in the art recognize that other kinds of additives can be incorporated into the polyethylene terephthalate polymers of the present invention. Such additives include, without limitation, colorants, antioxidants, flame retardants, melt strength enhancers, anti-static agents, lubricants, solvents, fillers, and plasticizers.

Although any of the above-referenced additives may be successfully incorporated into PET fibers, the invention herein imparts pest resistance to polymeric compositions by dehydrating the polymer with desiccant additives. In this regard, another embodiment of the invention is a method of forming a polymeric fiber that is resistant to pest infestation by admixing a pesticidal desiccant to a polymer melt. The admixing embeds the pesticidal desiccant into the polymer melt so that the desiccant is homogeneously dispersed within the melt. The invention includes another step of spinning the polymer-desiccant mixture. The result, of course, is a desirable melt-spun fiber with the pesticidal desiccant embedded therein to dehydrate the ambient moisture within and around the fiber to prevent pest infestation on the fiber. Again, the concept of “ambient moisture,” as used herein, means moisture formed by water molecules collecting at microscopic levels on and around the fiber. The pesticidal desiccant of the fiber dehydrates this microscopic reservoir of water and prevents the proliferation of microorganisms, particularly the dust mite.

The method of this invention incorporates all of the above-described desiccants, their compositions, and the concentrations of each. The references to each feature of the above described polymeric composition and resulting fibers will not be repeated here but apply equally to the method as claimed herein. The physical qualities of each desiccant, the concentrations by weight in the polymeric composition, and the types of polymers used in practicing the claimed method are all in accordance with the previously discussed embodiments.

In summary, the invention describe herein includes a fiber formed of a polymeric composition with a pesticidal desiccant homogeneously dispersed throughout the polymer. The method of forming the fiber is also disclosed and claimed. The desiccant is of appropriate size to be incorporated into a polymer melt for eventually forming articles, such as melt spun fibers, from the polymer-desiccant mix. Without limiting the invention to any particular theory of operation, the desiccant dehydrates microscopic reservoirs of water moisture that microorganisms need for survival.

The desiccant particle is of an appropriate size to be entirely embedded within the polymer. Without limiting the range of desiccants available for the invention herein, Table 1 shows particle properties for several exemplary desiccants that are available for use.

TABLE 1

| | Average | Maximum | Surface | Pore | |
|---|---|---|---|---|---|
| | Particle | Particle | Area, | Volume, | |
| | Size, | Size, | m2/g** | ml/g*** | S/V, |
| | microns* | microns | (S) | (V) | m2/ml |
| Precipitated Silica (Sipernat 22LS) | 4.5 | 45 | 190 | 2.53 | 75 |
| Precipitated Silica (HiSil T-690) | 1.7 | 10 | 170 | 1.44 | 118 |
| Diatomaceous Earth (Celatom | 5.0 | 45 | 35 | 1.25 | 28 |
| MN-23) | | | | | |
| Sodium Aluminum Silicate | 3.5 | 45 | Not | 0.48 | Not |
| (Sipernat 44MS) | | | Available | | Available |

*Malvern (laser)
**BET
***oil absorption

Embedding the pesticidal desiccant into the polymer allows the desiccant to dehydrate microscopic reservoirs of water that are deposited onto the fiber. The desiccant creates an arid environment at the level on which microorganisms, particularly the dust mite, live. For pesticidal purposes, the desiccant of this invention does not necessarily have to be exposed to the atmosphere to achieve the microscopic dehydration that effectively eliminates microorganisms from the polymer.

In fact, one study of various desiccants used according to this invention shows that the desiccant does not have to absorb moisture beyond the microscopic level to reduce pest infestation. The fiber with a desiccant additive therein does not absorb moisture from the air or the outside environment, i.e., beyond the microscopic ambient, any more so than a fiber without the desiccant. However, according to this study, the fiber with a desiccant does eliminate microorganisms, such as the dust mite.

To study these absorptive features of the invention, fiber produced on a laboratory spinneret (approximately 15 grams each) was dried in a forced-air oven at 105° C. for 24 hours and weighed to get a bone-dry weight. The fiber was allowed to stand at 21° C. and 65 percent relative humidity for 24 hours to pick up moisture before being weighed again. The weight gain in percent is defined as the difference in the two weights divided by the bone-dry weight and multiplied by 100.

Table 2 is useful to show the results of this test in determining the absorption properties of fibers with three different desiccant additives. The data show that the fibers with the desiccant do not significantly change in weight when exposed to an average relative humidity. The fiber of this invention, therefore, does not absorb significantly more moisture from the environment on a macroscopic level than would the same fiber without a desiccant additive. The fact that the desiccant kills microorganisms, especially the dust mite, indicates that the desiccant is providing a dry environment on a microscopic level. The dust mite and other microorganisms cannot survive in such arid microscopic surroundings.

TABLE 2

| | Percent powder in | Fiber Weight |
|---|---|---|
| | fiber | Gain (%) |
| Fiber Control | 0 | 0.42 |
| Fiber w/Precipitated Silica | 0.21 | 0.47 |
| | 0.53 | 0.42 |
| | 1.05 | 0.36 |
| Fiber w/Diatomaceous Earth | 0.42 | 0.45 |
| | 1.01 | 0.43 |
| | 1.59 | 0.50 |
| Fiber w/Sodium Aluminum Silicate | 0.75 | 0.42 |

Table 3 is indicative of the success by which a pesticidal desiccant added to the polymer melt reduces the infestation of dust mites on a fiber. Table 3 includes data for three desiccants that serve as examples only. Other desiccants available on the market today may provide similar reductions in the dust mite population.

Table 3 shows that dust mite reduction for selected desiccants remains high even after multiple washings. One would generally expect that washing a fabric would dislodge the desiccant and reduce the anti-pest quality of fibers. Table 3, however, shows that even 10 repetitive washings of polymeric fibers with pesticidal desiccants incorporated therein did not significantly diminish pesticidal quality.

The procedure for calculating the pesticidal efficacy of polymeric fibers subject to multiple washings is as follows. The fiber sample includes 20 to 25 grams of fiber placed into a 6-inch×6-inch pillowcase, which is sewn closed. The sewn pillow case is placed into the lab washer (Kenmore Heavy Duty 70 series). The fiber sample is washed with the washer set to warm wash (105° F.), cold rinse, high water level, cotton/sturdy wash type, and an extra heavy wash time (30 minutes). The test includes running the fiber sample, located within the pillow case, through this wash cycle for the specified number of times (i.e., 10, 20, or 30 washings). After the last wash cycle is complete, the sample within the pillow case is placed in the laboratory dryer (Kenmore Heavy Duty) on the cotton/sturdy setting. The sample completes the drying cycle with a drying time of 30 minutes at 140° F. After removing the fiber sample from the pillowcase, the fiber is tested to determine anti-dust mite efficacy.

This procedure was followed to prepare samples for anti-dust mite efficacy tests. These tests were conducted for control fibers with no desiccant, unwashed fibers containing a pesticidal desiccant, and desiccant-enhanced fibers that have been through multiple washings. The testing methodology follows standard AFNOR NF G 39-011 in which fibers treated with different additives are analyzed to determine the development of house dust mites thereon. The test proceeds by placing dust mites on the fiber samples and monitoring the development along a six week period corresponding to two development cycles.

The dust mites of these tests include dermatophagoides pteronyssinus and dermatophagoides farinae originating from a stock culture of I.N.R.A. Bordeaux (France). The strain was reared at 25° C. and 76 percent relative humidity for several years in laboratory conditions without any contact with insecticides on a oligidic diet of wheat germ (dried and powdered) and of brown brewer's yeast (prolabo, debittered, dried, and powdered) (1/1 w/w). The mites were retrieved from the surface of the rearing medium where the mite colony is generally concentrated.

The experiment utilizes 50 adult mites of mixed sex per experimental unit. The food source is Type I according to the standards. The assessment of mite survival is done using the “heating escape method” with low temperatures (30° C. to 40° C.) (Bischoff). Four replicates are conducted the same day for each fiber sample, including the untreated samples.

TABLE 3
Summary

| | Percent | Number | |
|---|---|---|---|
| | powder | of fiber | Percent reduction in |
| | in fiber | washings | dust mite population |
| Precipitated Silica | 0.21 | 0 | 100 |
| | | 10 | 88.6 |
| Diatomaceous Earth | 0.42 | 0 | 100 |
| | | 10 | 92.2 |
| Sodium Aluminum Silicate | 0.75 | 0 | 100 |
| | | 10 | 99.3 |

TABLE 4
Detailed Results (Mite type = D. farinae)

| | | | Percent |
|---|---|---|---|
| Fiber Type | Replicate | Mites Alive | Reduction |
| Control Fiber (untreated) | 1 | 863 | |
| | 2 | 847 | |
| | 3 | 884 | |
| | 4 | 903 | |
| | mean | 874 | |
| Precipitated Silica (0.21%) | 1 | 0 | 100 |
| 0 Washings | 2 | 0 | |
| | 3 | 0 | |
| | 4 | 0 | |
| | mean | 0 | |
| Precipitated Silica (0.21%) | 1 | 106 | 88.6 |
| 10 Washings | 2 | 88 | |
| | 3 | 121 | |
| | 4 | 83 | |
| | mean | 99 | |
| Diatomaceous Earth (0.42%) | 1 | 0 | 100 |
| 0 Washings | 2 | 0 | |
| | 3 | 0 | |
| | 4 | 0 | |
| | mean | 0 | |
| Diatomaceous Earth (0.42%) | 1 | 89 | 92.2 |
| 10 Washings | 2 | 53 | |
| | 3 | 70 | |
| | 4 | 62 | |
| | mean | 68 | |
| Sodium Aluminum Silicate | 1 | 0 | 100 |
| (0.75%) | 2 | 0 | |
| 0 Washings | 3 | 0 | |
| | 4 | 0 | |
| | mean | 0 | |
| Sodium Aluminum Silicate | 1 | 0 | 99.3 |
| (0.75%) | 2 | 11 | |
| 10 Washings | 3 | 9 | |
| | 4 | 6 | |
| | mean | 6 | |

The results listed in Tables 3 and 4 indicate that the listed desiccants showed a large reduction in the dust mite population even after as many as ten washings. The desiccant of the instant invention is embedded within the fiber. The desiccant particles remain in place within the polymer even after the washing process. These desiccants remain active to dehydrate the microscopic regions in which microorganisms thrive.

The pesticidal quality of the fiber, even after multiple washings, points out that the invention herein provides a highly durable pest resistance. Durability is a significant factor in pest control. Pesticides that are sprayed, sprinkled, absorbed, or otherwise applied to a fiber are often only temporarily affixed to a product. After multiple use or exposure, the pesticides wear off and are no longer present in the product. The invention herein is characterized by a higher durability because the pesticidal desiccant is embedded within the polymeric composition.

The invention requires no specific degree to which the desiccant must be exposed outside the polymer in order to add a pest resistant quality to an article. The desiccant of this invention, therefore, may be more permanently situated within the polymer. Handling, use, wear, washing, and other manipulation of an article incorporating a pesticidal desiccant, according to the disclosed method, is less likely to remove the desiccant from its position within the polymer. In this regard, the invention shows a durable pesticidal quality that has not been seen before in the field.

Table 5 shows the results of further durability testing for fibers with silica and diatomaceous earth as active ingredients. These tables include the percent reduction of the dust mite population for polymeric fibers that have been through the noted number of washings. Table 5 illustrates that the concentration of the active ingredient added to the fiber affects the pest reduction effectiveness at least as much, and possibly more, than the number of washings. For example, diatomaceous earth added to the fiber in a concentration by weight of one percent resulted in significantly better pest control qualities than a two percent sample, even when both were washed 50 times. These results show that one can determine the optimal concentration for the additive and be assured that the addictive will continue working upon multiple washes. The embedded desiccants of the invention are more likely to stay in place and continue working than additives of the prior art.

TABLE 5
(Mite type = D. farinae)

| | | Mites | Percent |
|---|---|---|---|
| Fiber Type | Replicate | Alive | Reduction |
| Untreated Control | 1 | 836 | N/A |
| | 2 | 874 | |
| | 3 | 840 | |
| | 4 | 892 | |
| | mean | 860 | |
| Precipitated Silica (0.75%) | 1 | 119 | 84.7 |
| 10 Washings | 2 | 124 | |
| | 3 | 151 | |
| | 4 | 132 | |
| | mean | 131 | |
| Diatomaceous Earth (1.0%) | 1 | 113 | 87.0 |
| 10 Washings | 2 | 126 | |
| | 3 | 108 | |
| | 4 | 102 | |
| | mean | 112 | |
| Precipitated Silica (1.5%) | 1 | 120 | 85.1 |
| 10 Washings | 2 | 143 | |
| | 3 | 136 | |
| | 4 | 114 | |
| | mean | 128 | |
| Diatomaceous Earth (2.0%) | 1 | 583 | 33.9 |
| 10 Washings | 2 | 522 | |
| | 3 | 601 | |
| | 4 | 570 | |
| | mean | 569 | |
| Precipitated Silica (0.2%) | 1 | 885 | −2.8 (i.e. increase) |
| 50 Washings | 2 | 872 | |
| | 3 | 877 | |
| | 4 | 903 | |
| | mean | 884 | |
| Diatomaceous Earth (0.4%) | 1 | 0 | 100.0 |
| 50 Washings | 2 | 0 | |
| | 3 | 0 | |
| | 4 | 0 | |
| | mean | 0 | |
| Precipitated Silica (0.75%) | 1 | 0 | 100.0 |
| 50 Washings | 2 | 0 | |
| | 3 | 0 | |
| | 4 | 0 | |
| | mean | 0 | |
| Diatomaceous Earth (1%) | 1 | 0 | 100.0 |
| 50 Washings | 2 | 0 | |
| | 3 | 0 | |
| | 4 | 0 | |
| | mean | 0 | |
| Precipitated Silica (1.5%) | 1 | 161 | 84.9 |
| 50 Washings | 2 | 134 | |
| | 3 | 117 | |
| | 4 | 108 | |
| | mean | 130 | |
| Diatomaceous Earth (2%) | 1 | 392 | 58.6 |
| 50 Washings | 2 | 335 | |
| | 3 | 371 | |
| | 4 | 328 | |
| | mean | 356 | |

In the drawing and the specification, typical embodiments of the invention have been disclosed. Specific terms have been used only in a generic and descriptive sense, and not for purposes of limitation. The scope of the invention is set forth in the following claims.

1. A polymeric composition having improved pest resistance, comprising:
a polymer matrix; and
a pesticidal desiccant for dehydrating ambient moisture, wherein:
said pesticidal desiccant is predominantly silicon dioxide;
said pesticidal desiccant is present in the polymeric composition in an amount between about 0.1 and 2.5 weight percent; and
said pesticidal desiccant is homogeneously dispersed throughout said polymer matrix.

2. A polymeric composition according to claim 1, wherein said pesticidal desiccant comprises particles embedded within said polymer matrix.

3. A polymeric composition according to claim 2, wherein said desiccant particles are sufficiently affixed within said polymer matrix to retain said desiccant particles in homogeneously dispersed positions within said polymer matrix, thereby enhancing the durability of the desiccant within said polymer matrix.

4. A polymeric composition according to claim 1, wherein said pesticidal desiccant is selected from the group consisting of precipitated silica, diatomaceous earth, sodium aluminum silicate, molecular sieve, montmorillonite clay, and mixtures thereof.

5. A polymeric composition according to claim 1, wherein said pesticidal desiccant is a silicon dioxide based powder.

6. A polymeric composition according to claim 1, wherein said desiccant comprises precipitated silica, said precipitated silica comprising, on a dry basis, between about 95 and 99 percent silicon dioxide (SiO₂), between about 0.5 and 2 percent sodium oxide (Na₂O), less than about 0.25 percent ferric oxide (Fe₂O₃), and between about 0.5 and 1.0 percent sulfur trioxide (SO₃) .

7. A polymeric composition according to claim 1, wherein said desiccant comprises diatomaceous earth, said diatomaceous earth comprising, on a dry basis, between about 88 and 92 percent silicon dioxide (SiO₂), between about 0.25 and 0.8 percent sodium oxide (Na₂O), between about 2 and 5 percent aluminum oxide (Al₂O₃), between about 0.5 and 3 percent ferric oxide (Fe₂O₃), and between about 2 and 5 percent other oxides.

8. A polymeric composition according to claim 1, wherein said desiccant comprises sodium aluminum silicate, said sodium aluminum silicate comprising, on a dry basis, between about 40 and 45 percent silicon dioxide (SiO₂), between about 20 and 25 percent sodium oxide (Na₂O), between about 32 and 38 percent aluminum oxide (Al₂O₃), and less than about 0.25 percent ferric oxide (Fe₂O₃).

9. A polymeric composition according to claim 1, wherein said desiccant is precipitated silica that is present in the composition in an amount between about 0.15 and about 0.75 weight percent.

10. A polymeric composition according to claim 1, wherein said desiccant is diatomaceous earth that is present in the composition in an amount between about 0.35 and about 1 weight percent.

11. A polymeric composition according to claim 1, wherein said desiccant is sodium aluminum silicate that is present in the composition in an amount between about 0.65 and about 0.8 weight percent.

12. A polymeric composition according to claim 1, wherein said polymer matrix is polyester.

13. A polymeric composition according to claim 1, wherein said polymer matrix is a nylon.

14. A polymeric composition according to claim 1, wherein said polymer matrix is selected from the group consisting of polyurethanes, polycarbonates, polyamides, polyimides, and polyolefins.

15. A filament formed of the polymeric composition according to claim 1.

16. A pest-resistant polymeric fiber, said fiber comprising:
polyethylene terephthalate; and
between about 0.1 and 2.5 weight percent of a pesticidal desiccant for dehydrating ambient moisture;
wherein, on a weight basis, said pesticidal desiccant is predominantly silicon dioxide; and
wherein said pesticidal desiccant is homogeneously dispersed throughout said fiber.

17. A pest-resistant polymeric fiber according to claim 16, wherein said pesticidal desiccant is embedded within the fiber.

18. A pest-resistant polymeric fiber according to claim 16, wherein said desiccant comprises particles having a surface area to volume ratio less than about 100 m²/ml.

19. A pest-resistant polymeric fiber according to claim 16, wherein said pesticidal desiccant is present in an amount between about 0.1 and 1 weight percent of said fiber.

20. A polymeric fiber according to claim 16, wherein said pesticidal desiccant is selected from the group consisting of precipitated silica, diatomaceous earth, sodium aluminum silicate, molecular sieve, montmorillonite clay, and mixtures thereof.

21. A method of forming a polymeric fiber that is resistant to pest infestation, comprising:
admixing a pesticidal desiccant to a polymer melt;
embedding the pesticidal desiccant into the polymer melt so that the desiccant is homogeneously dispersed within the melt; and
spinning the mixture of pesticidal desiccant and polymer melt to form a fiber with the pesticidal desiccant embedded therein to dehydrate the ambient moisture around the fiber.

22. A method of forming a polymeric fiber according to claim 21, wherein the step of admixing a pesticidal desiccant comprises adding a sufficient amount of the pesticidal desiccant so that the pesticidal desiccant is present in the polymer melt in an amount between about 0.1 and 2.5 weight percent.

23. A method of forming a polymeric fiber according to claim 21, wherein the step of admixing a pesticidal desiccant comprises adding a pesticidal desiccant powder with particles having a surface area to volume ratio less than about 100 m²/ml.

24. A method of forming a polymeric fiber according to claim 21, wherein the step of admixing a pesticidal desiccant comprises admixing a pesticidal desiccant to a nylon polymer melt.

25. A method of forming a polymeric fiber according to claim 21, wherein the step of admixing a pesticidal desiccant comprises admixing a pesticidal desiccant selected from the group consisting of precipitated silica, diatomaceous earth, sodium aluminum silicate, molecular sieve, montmorillonite clay, calcium oxide, calcium sulfate, aluminum oxide, and mixtures thereof.
